(19) United States
(12) Patent Application Publication
(10) Pub. No.: US 2013/0234980 A1
(43) Pub. Date: Sep. 12, 2013

(54) Touch Sensing Apparatus and Method

(71) Applicant: NUVOTON TECHNOLOGY CORPORATION, Hsinchu Science Park (TW)

(72) Inventor: Cheng-Chih Wang, Zhubei City (TW)

(73) Assignee: NUVOTON TECHNOLOGY CORPORATION, Hsinchu Science Park (TW)

(21) Appl. No.: 13/706,789

(22) Filed: Dec. 6, 2012

(30) Foreign Application Priority Data
Mar. 6, 2012 (TW) 101107506

(51) Int. Cl. G06F 3/041; G06F 3/044

(52) U.S. Cl. CPC G06F 3/041; G06F 3/044
USPC 345/174; 345/173; 178/18.03

(57) ABSTRACT

A touch sensing apparatus includes a touch sensing trace and a signal processing circuit. The touch sensing trace is configured to generate a sensing signal including a noise signal. A first input terminal of the signal processing circuit is configured to receive the sensing signal, and a second input terminal of the signal processing circuit is configured to receive a reference voltage signal and selectively coupled to at least one of first electrodes and second electrodes of the touch sensing trace, such that the second input terminal synchronously receives the reference voltage signal and the noise signal associated with the touch sensing trace.

### RELATED APPLICATIONS

This application claims priority to Taiwan Patent Application Serial Number 101107506, filed Mar. 6, 2012, which is herein incorporated by reference.

### BACKGROUND

1. Technical Field

The present disclosure relates to a sensing device and a sensing method. More particularly, the present disclosure relates to a touch sensing apparatus and a touch sensing method.

2. Description of Related Art

For high technology nowadays, user interfaces of more and more electronic products have already employed touch panels, such that demands for touch sensing apparatuses have increasingly matured. Touch sensing apparatuses have already become the basis of any kind of user interface, and replacing traditional keyboard interface touch sensing interface with touch sensing interface undoubtedly makes the user interface become more intuitional and easier for use.

Moreover, one of ordinary skill in the art can use the touch sensing interface to substitute mechanical keys necessary in various applications such as access control, mobile phone, MP3 player, personal computer peripherals, remote controller, etc., and costs for manufacturing products can thus be saved.

However, in touch sensing apparatuses, touch sensing panels usually may generate noise such that sensing signals outputted according to touch operations are often interfered, thereby resulting in that following operations based on the sensing signals may have errors. Thus, a touch sensing apparatus which is free from noise interference is necessary.

### SUMMARY

An aspect of the present disclosure is to provide a touch sensing apparatus comprising a touch sensing trace and a signal processing circuit. The touch sensing trace is configured for generating a sensing signal including a noise signal associated with the touch sensing trace, the touch sensing trace comprises a plurality of first electrodes and a plurality of second electrodes, and the first electrodes are interlaced or interleaved with the second electrodes. The signal processing circuit comprises a first input terminal and a second input terminal, the first input terminal is configured for receiving the sensing signal, and the second input terminal is electrically coupled to a reference voltage source for generating a reference voltage signal, in which the second input terminal is selectively coupled to at least one of the first electrodes and the second electrodes, such that the second input terminal synchronously receives the reference voltage signal and the noise signal associated with the touch sensing trace.

Another aspect of the present disclosure is to provide a touch sensing apparatus comprising a touch sensing trace and an analog-to-digital converter circuit. The touch sensing trace comprises a sensing array formed by a plurality of first electrodes and a plurality of second electrodes, in which at least one of the first electrodes is driven to couple with at least one of the second electrodes to form a sensing capacitance, the sensing array generates a sensing signal according to variations of the sensing capacitance, and the sensing signal includes a noise signal associated with the touch sensing trace. The analog-to-digital converter circuit comprises a first input terminal and a second input terminal, the first input terminal is configured for receiving the sensing signal, and the second input terminal is configured for receiving a reference voltage signal and selectively coupled to at least one of the first electrodes which are not driven, and at least one of the second electrodes, such that the noise signal associated with the touch sensing trace is superimposed on the reference voltage signal, in which the analog-to-digital converter circuit is configured for differentially processing the sensing signal and the reference voltage signal superimposed with the noise signal.

Still another aspect of the present disclosure is to provide a touch sensing method comprising the steps as described below. A sensing signal is generated according to sensing states of a touch sensing trace, in which the sensing signal includes a noise signal, and the noise signal is associated with the touch sensing trace. The noise signal is superimposed on a reference voltage signal. The sensing signal and the reference voltage signal superimposed with the noise signal are differentially processed to generate a differential voltage signal corresponding to the sensing states of the touch sensing trace.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference to the accompanying drawings as follows:

FIG. 1 is a schematic diagram illustrating a touch sensing apparatus according to one embodiment of the present disclosure;

FIG. 2 is a schematic diagram illustrating a touch sensing apparatus according to another embodiment of the present disclosure; and

FIG. 3 is a flowchart illustrating a touch sensing method according to one embodiment of the present disclosure.

### DESCRIPTION OF THE EMBODIMENTS

In the following description, specific details are presented to provide a thorough understanding of the embodiments of the present disclosure. Persons of ordinary skill in the art will recognize, however, that the present disclosure can be practiced without one or more of the specific details, or in combination with other components. Well-known implementations or operations are not shown or described in detail to avoid obscuring aspects of various embodiments of the present disclosure.

The terms used in this specification generally have their ordinary meanings in the art and in the specific context where each term is used. The use of examples anywhere in this specification, including examples of any terms discussed herein, is illustrative only, and in no way limits the scope and meaning of the disclosure or of any exemplified term. Likewise, the present disclosure is not limited to various embodiments given in this specification.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated, or meaning other approximate values.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

As used herein, the terms “comprising,” “including,” “having,” “containing,” “involving,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present disclosure. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may not be in direct contact with each other. “Coupled” may still be used to indicate that two or more elements cooperate or interact with each other.

The terms “in perpendicular to” and “in parallel with” regarding the vibrating directions also include “substantially in perpendicular to” and “substantially in parallel with”, respectively, throughout the specification and the claims of the present application.

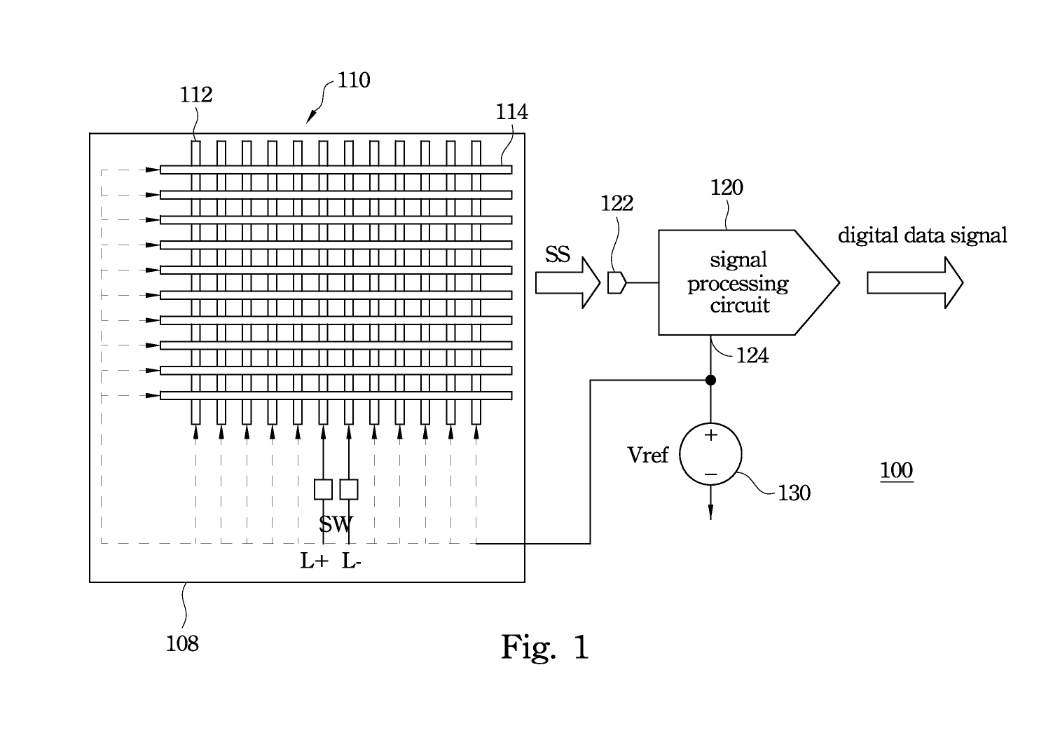

FIG. 1 is a schematic diagram illustrating a touch sensing apparatus according to one embodiment of the present disclosure. The touch sensing apparatus 100 includes a substrate 108, a touch sensing trace 110 and a signal processing circuit 120, in which the substrate 108 further includes a thin film transistor (TFT) liquid crystal panel, an organic light-emitting diode (OLED) panel, an electronic paper panel, a micro electromechanical (MEMS) panel, a glass substrate or a transparent substrate. If the touch sensing trace 110 in the present disclosure is disposed on a glass substrate, the touch sensing apparatus 100 is a touch panel. In addition, the touch sensing trace 110 also may be in a form of a thin film layer to be attached to the TFT liquid crystal panel, the OLED panel, the electronic paper panel or the MEMS panel, and the touch sensing apparatus 100 is an integrated touch panel or OGS (one glass solution) touch panel. Furthermore, the touch sensing trace 110 also may be integrated into display cells of the TFT liquid crystal panel or the OLED panel.

The touch sensing trace 110 is electrically coupled to the signal processing circuit 120. The touch sensing trace 110 includes a plurality of first electrodes 112 and a plurality of second electrodes 114, and the first electrodes 112 are interlaced or interleaved with the second electrodes 114. In one embodiment, the first electrodes 112 are in perpendicular to the second electrodes 114 to be interlaced with each other , in which the first electrodes 112 are Y-axis electrodes, and the second electrodes 114 are X-axis electrodes. In another embodiment, the first electrodes 112 and the second electrodes 114 also can be arranged in an interdigital way on a same horizontal plane (not shown). In still another embodiment, the first electrodes 112 and the second electrodes 114 also can be arranged without being perpendicular to each other. Moreover, the touch sensing trace 110 is configured for generating a sensing signal SS corresponding to touch events (i.e., the touch sensing trace 110 is touched or untouched), in which the sensing signal SS includes a noise signal, and the noise signal is associated with the touch sensing trace 110. The aforementioned disclosure that the noise signal is associated with the touch sensing trace 110 indicates that the touch sensing trace 110 itself has electrical interferences which may exist in conventional devices such that the outputted signal has disturbances and the noise signal is thus generated. However, it is not limited thereto; that is, any factor which is related to the touch sensing trace 110 and results in generating the noise signal is included.

In addition, the signal processing circuit 120 includes a first input terminal 122 and a second input terminal 124, in which the first input terminal 122 is configured for receiving the sensing signal SS generated by the touch sensing trace 110, the second input terminal 124 is electrically coupled to a reference voltage source 130, and the reference voltage source 130 is configured for generating a reference voltage signal Vref. Moreover, the second input terminal 124 is selectively coupled to at least one of the first electrodes 112 and the second electrodes 114, such that the noise signal associated with the touch sensing trace 110 is superimposed on the reference voltage signal Vref, and the second input terminal 124 synchronously receives the reference voltage signal Vref and the noise signal.

In one embodiment, the amount or the way of the first electrodes 112 and the second electrodes 114 being coupled to the second input terminal 124 can be modified fixedly or dynamically according to practical needs or designs, and also can be modified dynamically during the touch sensing operation by employing a programmable mechanism according to the touch sensing trace 110 itself and the noise signal associated therewith; however, it is not limited thereto.

In one embodiment, the first electrodes 112 are interlaced or interleaved with the second electrodes 114 to form a sensing array, at least one of the first electrodes 112 is driven to couple with at least one of the second electrodes 114 to form a sensing capacitance, and the sensing array generates the sensing signal SS according to variations of the sensing capacitance.

In another embodiment, in a sensing state, at least one of the first electrodes 112 is driven (for example, at least one of the first electrodes 112 is driven by driving signals L+ and L− shown in FIG. 1), and at least one of the undriven rest of the first electrodes 112 and at least one of the second electrodes 114 are coupled to the second input terminal 124.

In yet another embodiment, in the sensing state, two of the first electrodes 112 are driven by the driving signals L+ and L− respectively, and the rest of the first electrodes 112 and all of the second electrodes 114 are coupled to the second input terminal 124. On the other hand, the aforementioned driving signals L+ and L− also can selectively drive the first electrodes 112 through switches (e.g., switches SW as shown in FIG. 1).

It is noted that the aforementioned operation of the first electrodes 112 being driven by the driving signals L+ and L− is not performed by fixedly driving specific electrodes but dynamically driving the first electrodes 112, for example from left to right, with the driving signals L+ and L−.

In practice, the signal processing circuit 120 can be an analog-to-digital converter (ADC) circuit which is configured for converting the sensing signal SS generated by the touch sensing trace 110 into a digital data signal for other elements in the touch sensing apparatus 100 to perform related operations accordingly, and users may obtain results produced based on the operations on the touch sensing trace 110.

Furthermore, a voltage level of the reference voltage signal Vref may be set between a level of a power supply voltage and a level of a ground voltage. Moreover, an operation voltage for the signal processing circuit 120 can be the power supply voltage, and the level of the power supply voltage can be about twice the voltage level of the reference voltage signal Vref.

In one embodiment, the signal processing circuit 120 is configured for differentially processing the sensing signal SS received by the first input terminal 122 and the reference voltage signal Vref and the noise signal received by the second input terminal 124. Since the sensing signal SS is generated according to users' touch operations on the touch sensing trace 110, the sensing signal SS thus also includes the noise signal corresponding to the touch sensing trace 110. Moreover, the noise signal received by the second input terminal 124 is associated with the touch sensing trace 110, so when the signal processing circuit 120 differentially processes the sensing signal SS and the reference voltage signal Vref superimposed with the noise signal, the noise signals included in signals received by the first input terminal 122 and the second input terminal 124 can be cancelled (i.e., noise cancellation), such that the digital data signal outputted by the signal processing circuit 120 would not be affected by the noise signal, so as to improve the signal-to-noise ratio (SNR) and to prevent the subsequent circuits from being affected by the noise signal causing false actions.

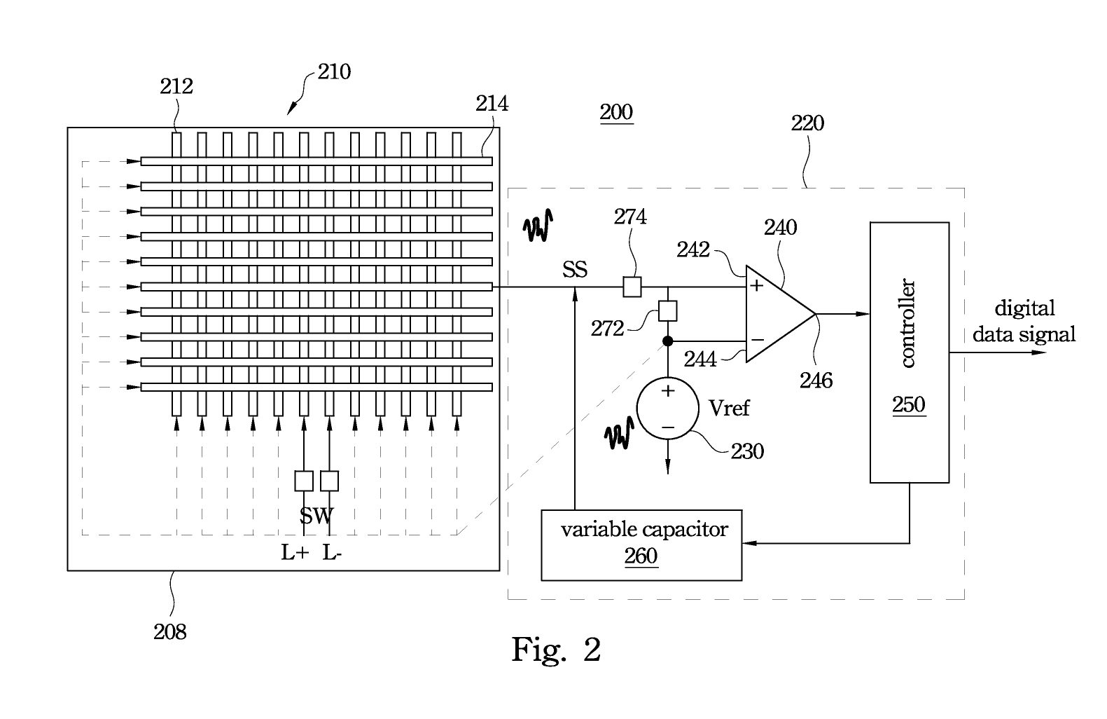

FIG. 2 is a schematic diagram illustrating a touch sensing apparatus according to another embodiment of the present disclosure. As shown in FIG. 2, the touch sensing apparatus 200 includes a substrate 208, a touch sensing trace 210 and a signal processing circuit 220, in which the substrate 208 includes a thin film transistor (TFT) liquid crystal panel, an organic light-emitting diode (OLED) panel, an electronic paper panel, a micro electromechanical (MEMS) panel, a glass substrate or a transparent substrate, the arrangements of the substrate 208 and the touch sensing trace 210 can be similar to those as mentioned above, and thus they are not further detailed herein.

The touch sensing trace 210 is electrically coupled to the signal processing circuit 220, and the touch sensing trace 210 includes a plurality of first electrodes 212 and a plurality of second electrodes 214. The arrangement and the operation of the touch sensing trace 210 are similar to the embodiment shown in FIG. 1, and thus they are not further detailed herein.

In addition, the signal processing circuit 220 may further include a comparator 240, and the comparator 240 includes a first comparator input 242, a second comparator input 244 and a comparator output 246. The first comparator input 242 is configured for receiving the sensing signal SS generated by the touch sensing trace 210. The second comparator input 244 is electrically coupled to a reference voltage source 230 and selectively coupled to at least one of the first electrodes 212 and the second electrodes 214, for receiving the reference voltage signal Vref and the noise signal associated with the touch sensing trace 210. The comparator output 246 is configured for outputting a differential voltage signal DVS.

Since the sensing signal SS is generated according to users' touch operations on the touch sensing trace 210, the sensing signal SS thus also includes the noise signal corresponding to the touch sensing trace 210. By using the comparator 240 to differentially process the sensing signal SS and the reference voltage signal Vref superimposed with the noise signal, the noise signal included in the sensing signal SS and the noise signal received by the second comparator input 244 can be counterbalanced (or canceled), such that the differential voltage signal DVS outputted by the comparator 240 can be free from being affected by the noise signal, so as to improve the signal-to-noise ratio (SNR) and to prevent the subsequent circuits from being affected by the noise signal causing false actions.

Moreover, the signal processing circuit 220 may further include a controller 250, and the controller 250 is configured for converting the differential voltage signal DVS into the digital data signal to be outputted for other elements in the touch sensing apparatus 200 to perform related operations accordingly.

In addition, the signal processing circuit 220 may further include a variable capacitor 260, in which the variable capacitor 260 is electrically coupled to the first comparator input 242 and the controller 250 and configured to be controlled by the controller 250. Furthermore, the variable capacitor 260 can have different equivalent capacitances according to the driving signals L+ and L− (i.e., the signals for dynamically driving the first electrodes 212) so as to perform capacitive compensation for the first comparator input 242 receiving the sensing signal SS, such that the variation of the sensing capacitance corresponding to the sensing signal SS can be obtained, and the subsequent corresponding digital data signal can be generated accordingly.

Moreover, in one embodiment, the reference voltage source 230 can be disposed in the signal processing circuit 220 and electrically coupled to the second comparator input 244. In another embodiment, the reference voltage source 230 is disposed outside the signal processing circuit 220 and electrically coupled to the second comparator input 244.

Furthermore, as shown in FIG. 2, the signal processing circuit 220 can further include a first switch 272 and a second switch 274, in which the first switch 272 is coupled between the first comparator input 242 and the second comparator input 244, and the second switch 274 is coupled between the first comparator input 242 and the touch sensing trace 210.

In one embodiment, in an initial state (e.g., the touch sensing apparatus 200 cannot perform touch sensing operations), the first switch 272 turns on to conduct the first comparator input 242 with the second comparator input 244 and the second switch 274 turns off, and in a sensing state (e.g., the touch sensing apparatus 200 can perform touch sensing operations), the first switch 272 turns off and the second switch 274 turns on to conduct the first comparator input 242 with the touch sensing trace 210.

On the other hand, the driving signals L+ and L− also can selectively drive the first electrodes 212 through switches respectively through switches (e.g., switches SW as shown in FIG. 2) and be selectively transmitted to the variable capacitor 260 for operations.

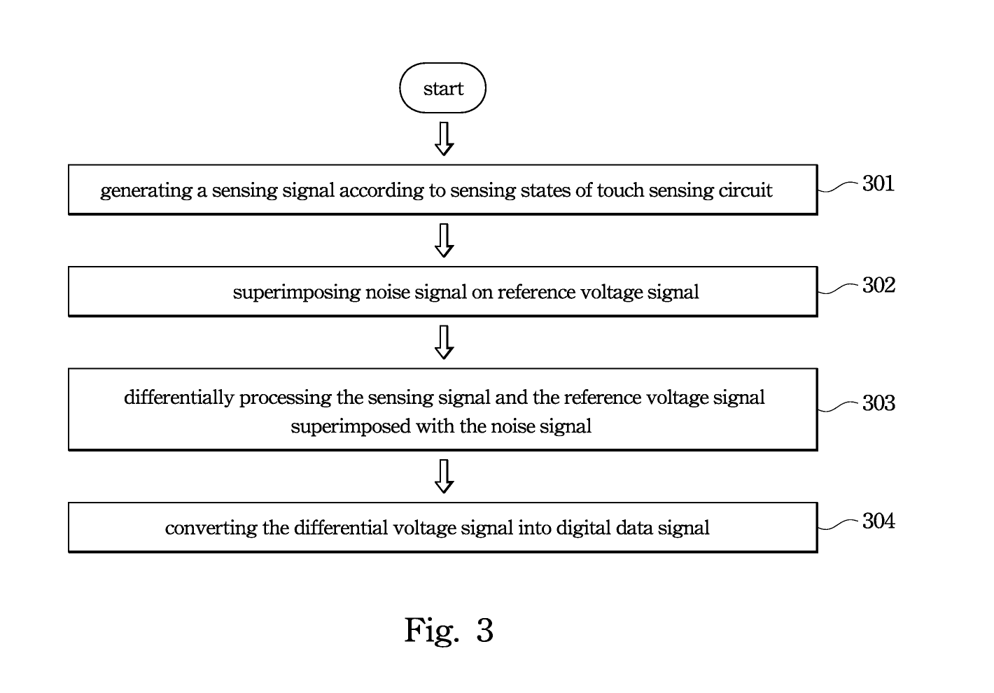

FIG. 3 is a flowchart illustrating a touch sensing method according to one embodiment of the present disclosure. The touch sensing method is applicable to the touch sensing apparatuses as shown in FIG. 1 and FIG. 2. For clear descriptions, the touch sensing method in the present embodiment is described in conjunction with the touch sensing apparatus 200 shown in FIG. 2, and however, it is not limited thereto.

As shown in FIG. 2 and FIG. 3, the sensing signal SS is first generated according to sensing states of the touch sensing trace 210 (Step 301), in which the sensing signal SS includes a noise signal, and the noise signal is associated with the touch sensing trace 210. Then, the noise signal is superimposed on a reference voltage signal Vref (Step 302). Thereafter, the sensing signal SS and the reference voltage signal Vref superimposed with the noise signal are differentially processed to generate a differential voltage signal DVS corresponding to the sensing states of the touch sensing trace (Step 303), such that the noise signal in the sensing signal SS and the noise signal superimposed with the reference voltage signal Vref can be counterbalanced (or canceled), and the generated differential voltage signal DVS thus can be free from being affected by the noise signal, so as to improve the signal-to-noise ratio (SNR) and to prevent the subsequent circuits from being affected by the noise signal causing false actions.

In another embodiment, the operation of differentially processing the sensing signal SS and the reference voltage signal Vref superimposed with the noise signal, as mentioned at the Step 303, can be performed by a comparator (e.g., the comparator 240 shown in FIG. 2) for comparing the sensing signal SS and the reference voltage signal Vref superimposed with the noise signal.

Furthermore, the touch sensing method can further include converting the differential voltage signal DVS into a digital data signal (Step 304) (for example, by the controller 250 shown in FIG. 2), such that the digital data signal can be provided for other elements in the touch sensing apparatus 200 to perform related operations accordingly.

For the aforementioned embodiments of the present disclosure, in the touch sensing apparatus, the signal processing circuit (e.g., the analog-to-digital converter circuit) is coupled to both of the touch sensing trace and the undriven electrodes therein, and thus the signal processing circuit synchronously receives the corresponding sensing signal generated by the touch sensing trace and the reference voltage signal superimposed with the noise signal and differentially processes the same signals (or further compares the same signals), such that the noise signals can be counterbalanced (or canceled). Therefore, compared to conventional skills, the digital data signal correspondingly outputted by the signal processing circuit in the embodiments of the present disclosure would not be affected by the noise signal, so as to improve the signal-to-noise ratio (SNR) and to prevent the subsequent circuits from being affected by the noise signal causing false actions.

The steps are not necessarily recited in the sequence in which the steps are performed. That is, unless the sequence of the steps is expressly indicated, the sequence of the steps is interchangeable, and all or part of the steps may be simultaneously, partially simultaneously, or sequentially performed.

As is understood by a person skilled in the art, the foregoing embodiments of the present disclosure are illustrative of the present disclosure rather than limiting of the present disclosure. It is intended to cover various modifications and similar arrangements included within the spirit and scope of the appended claims, the scope of which should be accorded with the broadest interpretation so as to encompass all such modifications and similar structures.

What is claimed is:

1. A touch sensing apparatus comprising:
a touch sensing trace for generating a sensing signal including a noise signal associated with the touch sensing trace, the touch sensing trace comprising a plurality of first electrodes and a plurality of second electrodes, the first electrodes interlaced or interleaved with the second electrodes; and
a signal processing circuit comprising a first input terminal and a second input terminal, the first input terminal configured for receiving the sensing signal, the second input terminal electrically coupled to a reference voltage source for generating a reference voltage signal, wherein the second input terminal is selectively coupled to at least one of the first electrodes and the second electrodes, such that the second input terminal synchronously receives the reference voltage signal and the noise signal associated with the touch sensing trace.

2. The touch sensing apparatus as claimed in claim 1, wherein the signal processing circuit is configured for differentially processing the sensing signal received by the first input terminal, and the reference voltage signal and the noise signal received by the second input terminal.

3. The touch sensing apparatus as claimed in claim 1, wherein the signal processing circuit further comprises:
a comparator comprising a first comparator input, a second comparator input and a comparator output, the first comparator input configured for receiving the sensing signal, the second comparator input configured for receiving the reference voltage signal and the noise signal, the comparator output configured for outputting a differential voltage signal.

4. The touch sensing apparatus as claimed in claim 3, wherein the signal processing circuit further comprises:
a controller configured for converting the differential voltage signal into a digital data signal.

5. The touch sensing apparatus as claimed in claim 4, wherein the signal processing circuit further comprises:
a variable capacitor electrically coupled to the first comparator input and the controller, and configured to be controlled by the controller.

6. The touch sensing apparatus as claimed in claim 3, wherein the reference voltage source is disposed in the signal processing circuit and electrically coupled to the second comparator input.

7. The touch sensing apparatus as claimed in claim 3, wherein the signal processing circuit further comprises:
a first switch coupled between the first comparator input and the second comparator input; and
a second switch coupled between the first comparator input and the touch sensing trace.

8. The touch sensing apparatus as claimed in claim 7, wherein in an initial state, the first switch turns on to conduct the first comparator input with the second comparator input and the second switch turns off, and in a sensing state, the first switch turns off and the second switch turns on to conduct the first comparator input with the touch sensing trace.

9. The touch sensing apparatus as claimed in claim 1, wherein in a sensing state, at least one of the first electrodes is driven, and at least one of the first electrodes which are not driven and at least one of the second electrodes are coupled to the second input terminal.

10. The touch sensing apparatus as claimed in claim 1, wherein the signal processing circuit is an analog-to-digital converter circuit.

11. The touch sensing apparatus as claimed in claim 1, wherein an operation voltage for the signal processing circuit is a power supply voltage, and a level of the power supply voltage is about twice a voltage level of the reference voltage signal.

12. A touch sensing apparatus comprising:
a touch sensing trace comprising a sensing array formed by a plurality of first electrodes and a plurality of second electrodes, wherein at least one of the first electrodes is driven to couple with at least one of the second electrodes to form a sensing capacitance, the sensing array generates a sensing signal according to variations of the sensing capacitance, and the sensing signal includes a noise signal associated with the touch sensing trace; and
an analog-to-digital converter circuit comprising a first input terminal and a second input terminal, the first input terminal configured for receiving the sensing signal, the second input terminal configured for receiving a reference voltage signal and selectively coupled to at least one of the first electrodes which are not driven and at least one of the second electrodes, such that the noise signal associated with the touch sensing trace is superimposed on the reference voltage signal, wherein the analog-to-digital converter circuit is configured for differentially processing the sensing signal and the reference voltage signal superimposed with the noise signal.

13. The touch sensing apparatus as claimed in claim 12, wherein the analog-to-digital converter circuit further comprises:
a comparator comprising a first comparator input, a second comparator input and a comparator output, the first comparator input configured for receiving the sensing signal, the second comparator input configured for receiving the reference voltage signal superimposed with the noise signal, the comparator output configured for outputting a differential voltage signal.

14. The touch sensing apparatus as claimed in claim 13, wherein the analog-to-digital converter circuit further comprises:
a controller configured for converting the differential voltage signal into a digital data signal.

15. The touch sensing apparatus as claimed in claim 14, wherein the analog-to-digital converter circuit further comprises:
a variable capacitor electrically coupled to the first comparator input and the controller, and configured to be controlled by the controller.

16. The touch sensing apparatus as claimed in claim 13, wherein the analog-to-digital converter circuit further comprises:
a first switch coupled between the first comparator input and the second comparator input, the first switch turning on to conduct the first comparator input with the second comparator input in an initial state; and
a second switch coupled between the first comparator input and the touch sensing trace, the second switch turning on to conduct the first comparator input with the touch sensing trace in a sensing state.

17. The touch sensing apparatus as claimed in claim 12, wherein an operation voltage for the analog-to-digital converter circuit is a power supply voltage, and a level of the power supply voltage is about twice a voltage level of the reference voltage signal.

18. A touch sensing method comprising:
generating a sensing signal according to sensing states of a touch sensing trace, wherein the sensing signal includes a noise signal, and the noise signal is associated with the touch sensing trace;
superimposing the noise signal on a reference voltage signal; and
differentially processing the sensing signal and the reference voltage signal superimposed with the noise signal to generate a differential voltage signal corresponding to the sensing states of the touch sensing trace.

19. The touch sensing method as claimed in claim 18, further comprising:
converting the differential voltage signal into a digital data signal.

20. The touch sensing method as claimed in claim 18, wherein the step of differentially processing the sensing signal and the reference voltage signal superimposed with the noise signal further comprises:
comparing the sensing signal and the reference voltage signal superimposed with the noise signal by a comparator.
